(19) United States
(12) Patent Application Publication
(10) Pub. No.: US 2024/0036212 A1
(43) Pub. Date: Feb. 1, 2024

(54) LANE BOUNDARY DETECTION USING SUB-SHORT RANGE ACTIVE LIGHT SENSOR

(71) Applicant: Atieva, Inc., Newark, CA (US)

(72) Inventor: Qiang Lu, Foster City, CA (US)

(21) Appl. No.: 18/192,611

(22) Filed: Mar. 29, 2023

Related U.S. Application Data
(60) Provisional application No. 63/370,037, filed on Aug. 1, 2022.

(51) Int. Cl. G01S 17/931; G06V 20/56; G01S 17/89; B60W 40/06; B60W 50/14

(52) U.S. Cl. CPC G01S 17/931; G06V 20/588; G01S 17/89; B60W 40/06; B60W 50/14; B60W 2420/52

(57) ABSTRACT

A vehicle comprises: a vehicle body; a sub-short range active light sensor mounted to the vehicle body and configured to detect a lane boundary of a surface on which the vehicle is traveling; and an advanced driver-assistance system configured to register a lane boundary detection by the sub-short range active light sensor and perform an action in response to the lane boundary detection.

### CROSS-REFERENCE TO RELATED APPLICATION

This application claims benefit, under 35 U.S.C. § 119, of U.S. Provisional Patent Application No. 63/370,037, filed on Aug. 1, 2022, entitled “LANE BOUNDARY DETECTION USING SUB-SHORT RANGE ACTIVE LIGHT SENSOR,” the disclosure of which is incorporated by reference herein in its entirety.

### TECHNICAL FIELD

This document relates to detection of a lane boundary using a sub-short range active light sensor of a vehicle.

### BACKGROUND

Some vehicles manufactured nowadays are equipped with one or more types of systems that can at least in part handle operations relating to the driving of the vehicle. Some such assistance involves automatically surveying surroundings of the vehicle and being able to take action regarding detected vehicles, pedestrians, or objects.

### SUMMARY

In a first aspect, a vehicle comprises: a vehicle body; a sub-short range active light sensor mounted to the vehicle body and configured to detect a lane boundary of a surface on which the vehicle is traveling; and an advanced driver-assistance system (ADAS) configured to register a lane boundary detection by the sub-short range active light sensor and perform an action in response to the lane boundary detection.

Implementations can include any or all of the following features. The sub-short range active light sensor is mounted underneath the vehicle, at an end in a longitudinal direction of the vehicle, or at a side of the vehicle. The sub-short range active light sensor is configured to detect a lane marking as the lane boundary. The sub-short range active light sensor is configured to detect a road marker as the lane boundary. The sub-short range active light sensor is configured to detect an elevation difference in the surface as the lane boundary. The sub-short range active light sensor generates a first output, the vehicle further comprising: a sensor mounted to the vehicle to generate a second output; and a sensor fusion component configured to fuse the first and second outputs with each other. The sensor includes an audio sensor and wherein the second output is based on detecting audio using the audio sensor. The audio is generated by a wheel of the vehicle contacting a road marker on the surface. The sensor includes a vibration sensor and wherein the second output is based on detecting vibration using the vibration sensor. The vibration is generated by a wheel of the vehicle contacting a road marker on the surface. The lane boundary detection comprises at least one of detecting a lane boundary of the surface, or detecting an absence of the lane boundary. The ADAS is configured to control motion of the vehicle based on registering the lane boundary detection. The ADAS is configured to generate an alert based on registering the lane boundary detection. The sub-short range active light sensor performs scanning in one dimension only. The sub-short range active light sensor performs scanning in two dimensions. The sub-short range active light sensor includes a flash light ranging and detection device. The sub-short range active light sensor includes a triangulation light ranging and detection device. The vehicle has multiple sub-short range active light sensors, and wherein the lane boundary is detected using at least one of the multiple sub-short range active light sensors. The sub-short range active light sensor includes a light source and a light detector, and wherein the light source and the light detector are positioned in a common housing. The sub-short range active light sensor includes a light source and a light detector, and wherein the light source and the light detector are not positioned in a common housing. The sub-short range active light sensor includes the light source and multiple light detectors, wherein the multiple light detectors are installed at different locations on the vehicle, and wherein light emission of the light source and operation of the multiple light detectors are synchronized with each other. The light source is integrated in a headlight of the vehicle.

In a second aspect, a method comprises: detecting a lane boundary of a surface on which a vehicle is traveling, the lane boundary detected using a sub-short range active light sensor mounted to the vehicle; and performing, using an advanced driver-assistance system, an action in response to the detection of the lane boundary.

Implementations can include any or all of the following features. Detecting the lane boundary includes detecting an angle of the vehicle with regard to the lane boundary from output of the sub-short range active light sensor as a single sensor. Multiple sub-short range active light sensors are mounted to the vehicle, and wherein detecting the lane boundary includes detecting an angle of the vehicle with regard to the lane boundary from output of the multiple sub-short range active light sensors. Detecting the lane boundary includes detecting a height of a region of a surface. Detecting the lane boundary includes detecting a light reflection intensity of a road marker. Detecting the lane boundary comprises receiving first output from the sub-short range active light sensor and second output from a sensor of the vehicle, and fusing the first and second outputs with each other. The sensor includes an audio sensor and wherein the second output is based on detecting audio using the audio sensor. The sensor includes a vibration sensor and wherein the second output is based on detecting vibration using the vibration sensor. The method further comprises adjusting, by the vehicle, a setting of the sub-short range active light sensor based on sensor data from the sub-short range active light sensor. The sensor data is received from at least one the sub-short range active light sensor or another sensor of the vehicle.

### BRIEF DESCRIPTION OF DRAWINGS

FIG. 1A shows a top view of an example of a vehicle traveling on a surface.

FIG. 1B shows other examples relating to the vehicle in FIG. 1A.

FIG. 2 shows a rear view of an example of a vehicle traveling on a surface.

FIG. 3 shows an example graph of a reflection intensity signal measured by a light sensor relating to detecting a lane boundary.

FIG. 4 shows an example of a geometric relationship between the position of a sub-short range active light sensor mounted on a vehicle, and a lane boundary on a surface.

FIG. 5 shows a top view of an example of a vehicle having a sub-short range active light sensor.

FIG. 6 shows a top view of an example of a vehicle having sub-short range active light sensors.

FIG. 7 shows a rear view of an example of a vehicle traveling on a surface.

FIG. 8 shows an example of a system.

FIG. 9A shows examples of a flash LiDAR, a scanning LiDAR, and a triangulation LiDAR.

FIG. 9B shows an example involving the flash LiDAR of FIG. 9A.

FIG. 10 shows an example of a vehicle.

FIG. 11 shows an example of a method.

FIG. 12 illustrates an example architecture of a computing device that can be used to implement aspects of the present disclosure.

Like reference symbols in the various drawings indicate like elements.

### DETAILED DESCRIPTION

This document describes examples of systems and techniques for improved lane detection in a vehicle. A relatively inexpensive active light sensor (such as, but not limited to, a light ranging and detection (LiDAR) device) can be mounted to the vehicle so that the active light sensor has a view of a lane boundary of the surface on which the vehicle is traveling, and the active light sensor can be used for lane detection. In some implementations, two or more sensor outputs of the vehicle can be fused in making a lane boundary detection. One or more actions can be automatically performed in response to a lane boundary detection, including, but not limited to, controlling the motion of the vehicle, or generating an alert to a passenger.

Lane detection can be seen as part of the foundation of some or all advanced driving-assistance systems (ADAS). Lane detection can be part of, or used with, features such as lane centering, lane departure warnings, lateral control, among others. Some present approaches of ADASs may use a long-range camera or a long-range LiDAR for imaging the roadway. However, this can be associated with a relatively high cost of components, or severe impact from unfavorable ambient conditions, or both. For example, some existing ADASs are based on computer vision (e.g., camera or LiDAR) and require detection of distant lane markers on the roadway in order for the system to perform curve fitting and extrapolation. Such ADASs can suffer performance degradation due to poor weather conditions, including rain, snow or fog; and/or unfavorable ambient lighting, including low light, wet surfaces, or glare.

Using a LiDAR instead of, or in combination with, a camera can improve the situation, but this approach is also associated with disadvantages. Some existing LiDAR devices claim to have a maximum range of about 200 m, sometimes about 300 m. These LiDAR devices, including those having a maximum range beyond about 100 m, are sometimes referred to as long-range LiDAR. Long-range LiDAR devices are sometimes used for highway driving where a farther viewing distance is needed to provide more time for taking action due to the greater speed of the vehicle. They are generally very expensive due to the complex technology they contain. LiDAR devices with somewhat shorter maximum range, such as up to about 30-50 m, are sometimes referred to as short-range LiDAR. Short-range LiDAR devices are sometimes used for urban driving, cut-in detection, or blind spot detection, and are generally associated with considerable costs.

The use of a forward-facing LiDAR device in a vehicle has its limitations, including that the incident angle between the LiDAR ray and the road surface is very large (e.g., close to 90 degrees); that the laser beam diverges over great distance, leading to a very low detection signal for such responses; and that the mounting position on the vehicle may not be sufficiently elevated to improve the above conditions. As an example, a long-range LiDAR device currently used for automotive applications may be able to detect lane markers at about 50 meters (m) during good weather. Moreover, such long-range LiDAR devices are relatively expensive, and may require additional computing resources for post-processing of the device output. As a result, obtaining further improvement on the currently applied approaches for detection of lane boundaries can be relatively costly.

In some implementations, the present subject matter provides one or more approaches for addressing situations such as the ones described above. One or more relatively inexpensive active light sensors can be used for scanning the road surface near the vehicle during travel. In some implementations, a single active light sensor can be used for detecting lane markers based on the contrast in return signal intensity. In some implementations, one or more frames of sensor signal can be fused with output from another sensor, including, but not limited to, an inertial measurement unit, or a global navigation system (e.g., a global positioning system or a global navigation satellite system). Fusing with mapping information (e.g., high-definition map data) can be performed. In some implementations, multiple active light sensors can be used, such as to estimate lane width, ego vehicle position, and angle. In the present subject matter, an active light sensor can perform scanning in one or more dimensions. For example, a two-dimension (2D) active light sensor can scan along only one dimension, and a three-dimension (3D) active light sensor can scan along two dimensions. The present subject matter is able to achieve lane boundary detection at significantly lower cost than is previous approaches. For example, the active light sensor may not need to have a long maximum range, but instead a very short detection range can be used. The active light sensor can use higher frame rates than what is typically used with current approaches, leading to an increase in accuracy.

Examples herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle, or the vehicle can be unpowered (e.g., when a trailer is attached to another vehicle). The vehicle can include a passenger compartment accommodating one or more persons. At least one vehicle occupant can be considered the driver; various tools, implements, or other devices, can then be provided to the driver. In examples herein, any person carried by a vehicle can be referred to as a “driver” or a “passenger” of the vehicle, regardless whether the person is driving the vehicle, or whether the person has access to controls for driving the vehicle, or whether the person lacks controls for driving the vehicle. Vehicles in the present examples are illustrated as being similar or identical to each other for illustrative purposes only.

Examples herein refer to an ADAS. In some implementations, an ADAS can perform assisted driving and/or autonomous driving. An ADAS can at least partially automate one or more dynamic driving tasks. An ADAS can operate based in part on the output of one or more sensors typically positioned on, under, or within the vehicle. An ADAS can plan one or more trajectories for a vehicle before and/or while controlling the motion of the vehicle. A planned trajectory can define a path for the vehicle's travel. As such, propelling the vehicle according to the planned trajectory can correspond to controlling one or more aspects of the vehicle's operational behavior, such as, but not limited to, the vehicle's steering angle, gear (e.g., forward or reverse), speed, acceleration, and/or braking.

While an autonomous vehicle is an example of an ADAS, not every ADAS is designed to provide a fully autonomous vehicle. Several levels of driving automation have been defined by SAE International, usually referred to as Levels 0, 1, 2, 3, 4, and 5, respectively. For example, a Level 0 system or driving mode may involve no sustained vehicle control by the system. For example, a Level 1 system or driving mode may include adaptive cruise control, emergency brake assist, automatic emergency brake assist, lane-keeping, and/or lane centering. For example, a Level 2 system or driving mode may include highway assist, autonomous obstacle avoidance, and/or autonomous parking. For example, a Level 3 or 4 system or driving mode may include progressively increased control of the vehicle by the assisted-driving system. For example, a Level 5 system or driving mode may require no human intervention of the assisted-driving system.

Examples herein refer to a lane for a vehicle. As used herein, a lane is a path traveled by a vehicle currently, in the past, or in the future; the path where the vehicle is currently located can be referred to as an ego lane. By contrast, a lane towards which the vehicle may be directed to travel is sometimes referred to as a target lane. A lane may be, but is not necessarily, defined by one or more markings on or adjacent the roadway. The distinction between one lane and another lane can be visually noticeable to a passenger, or can be solely defined by the ADAS, to name just two examples. A lane as used herein includes a straight roadway (e.g., free of turns) and a roadway making one or more turns. A lane as used herein can be part of a roadway that is restricted to one-way travel (e.g., a one-way street), or can be part of a roadway allowing two-way traffic. A lane as used herein can be part of a roadway that has only a single lane, or that has multiple lanes. In the present subject matter, an ego lane and a target lane can be, but are not necessary, essentially parallel to each other. For example, one of the ego lane and the target lane can form a nonzero angle relative to the other.

Examples herein refer to a lane boundary. As used herein, a lane boundary includes any feature that an ADAS can detect to perceive that a lane ends or begins in any direction. A lane boundary includes, but is not limited to, a lane marking, a road marker, or an elevation difference. A lane marking includes, but is not limited to, an area of the surface that is visually contrasted from another area of the surface to mark the boundary of a lane. The lane marking can be formed by paint or other pigmented material applied to the road surface (e.g., a solid line, a double line, a white line, a yellow line, a short broken line, or a long broken line), or by a different surface material (e.g., stone, brick or a synthetic material embedded in a road top surface), to name just a few examples. A road marker includes, but is not limited to, a Botts' dot, a so-called turtle, a so-called button, a pavement marker, a rumble strip, a reflective marker, a non-reflective marker, a marker raised above the surface, a marker lowered below the surface, and combinations thereof, to name just a few examples. An elevation difference includes, but is not limited to, an increase in elevation (e.g., a curb) marking the boundary of a lane, or a decrease in elevation (e.g., the edge of a raised roadway surface) marking the boundary of a lane.

Examples herein refer to a sensor. A sensor is configured to detect one or more aspects of its environment and output signal(s) reflecting the detection. The detected aspect(s) can be static or dynamic at the time of detection. As illustrative examples only, a sensor can indicate one or more of a distance between the sensor and an object, a speed of a vehicle carrying the sensor, a trajectory of the vehicle, or an acceleration of the vehicle. A sensor can generate output without probing the surroundings with anything (passive sensing, e.g., like an image sensor that captures electromagnetic radiation), or the sensor can probe the surroundings (active sensing, e.g., by sending out electromagnetic radiation and/or sound waves) and detect a response to the probing. Examples of sensors that can be used with one or more embodiments include, but are not limited to: a light sensor (e.g., a camera); a light-based sensing system (e.g., a light ranging and detection (LiDAR) device); a radio-based sensor (e.g., radar); an acoustic sensor (e.g., an ultrasonic device and/or a microphone); an inertial measurement unit (e.g., a gyroscope and/or accelerometer); a speed sensor (e.g., for the vehicle or a component thereof); a location sensor (e.g., for the vehicle or a component thereof); an orientation sensor (e.g., for the vehicle or a component thereof); a torque sensor; a thermal sensor; a temperature sensor (e.g., a primary or secondary thermometer); a pressure sensor (e.g., for ambient air or a component of the vehicle); a humidity sensor (e.g., a rain detector); or a seat occupancy sensor.

Examples herein refer to an active light sensor. As used herein, an active light sensor includes any object detection system that is based at least in part on light, wherein the system emits the light in one or more directions. The light can be generated by a laser and/or by a light-emitting diode (LED), to name just two examples. The active light sensor can emit light pulses in different directions (e.g., characterized by different polar angles and/or different azimuthal angles) so as to survey the surroundings. For example, one or more laser beams can be impinged on an orientable reflector for aiming of the laser pulses. An active light sensor can include a LiDAR. In some implementations, a LiDAR can include a frequency-modulated continuous wave (FMCW) LiDAR. For example, the FMCW LiDAR can use non-pulsed scanning beams with modulated (e.g., swept or “chirped”) frequency, wherein the beat between the emitted and detected signals is determined. In some implementations, a LiDAR can include a triangulation LiDAR. For example, the triangulation LiDAR can use laser-based multidimensional spatial sensing in combination with thermal imaging. A LiDAR can be a scanning LiDAR or a non-scanning LiDAR (e.g., a flash LiDAR), to name just some examples. The active light sensor can detect the return signals by a suitable sensor to generate an output.

Examples herein refer to a sub-short range active light sensor. The range of a sub-short range active light sensor is less than (e.g., significantly less than) the range of a short-range active light sensor. The use of a sub-short range active light sensor for lane boundary detection in an automotive application is based on the recognition that one does not need the range of a long-range active light sensor or even that of a short-range active light sensor to detect a lane boundary that is relatively near the vehicle. In some implementations, a maximum range of only less than about 3 m, such as only less than about 1-2 m, may be sufficient. This presents significantly different technical requirements than in earlier approaches and very high emission power from the active light sensor is not needed. In any event, with too strong a return signal from a nearby lane boundary, the active light sensor may saturate if a high emission power were used. As such, relatively low emission power can be used, optionally in combination with an increased frame rate of the active light sensor.

As used herein, a sub-short range active light sensor includes only active light sensors having a maximum range that is less than about 3 m. In some implementations, a sub-short range active light sensor can have a maximum range that is less than about 2 m. In some implementations, a sub-short range active light sensor can have a maximum range that is less than about 1 m. In some implementations, a sub-short range active light sensor can have an operating power of less than about 5 Watts (W). In some implementations, a sub-short range active light sensor can have an operating power of less than about 1 W. In some implementations, a sub-short range active light sensor can operate with a frame rate of more than about 20 frames per second (fps). In some implementations, a sub-short range active light sensor can operate with a frame rate of more than about 50 fps. In some implementations, a sub-short range active light sensor can operate with a frame rate of more than about 100 fps.

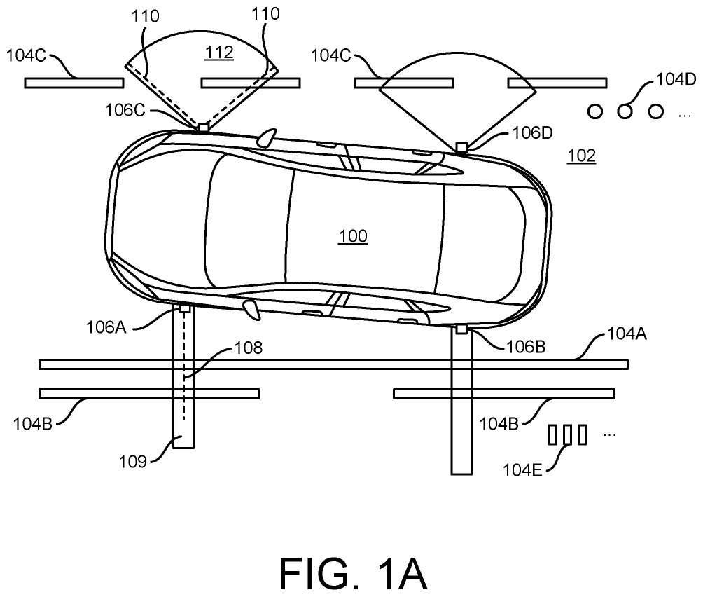

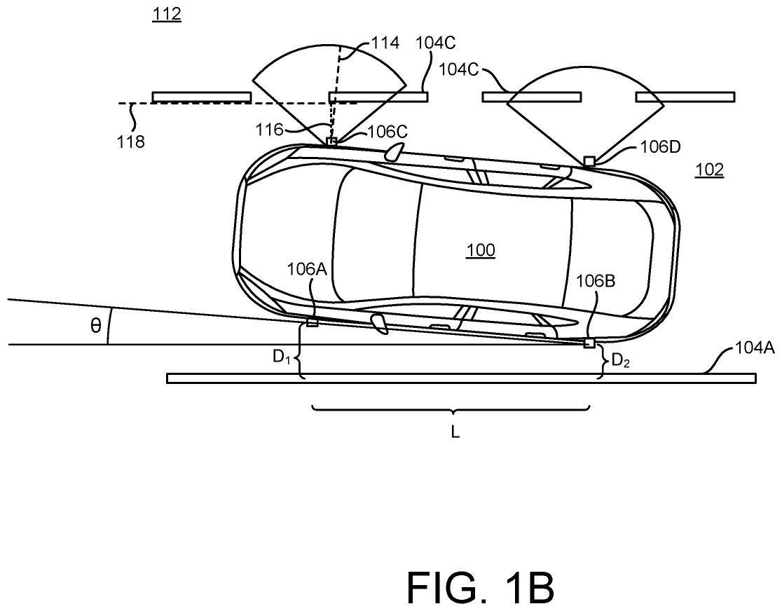

FIG. 1A shows a top view of an example of a vehicle 100 traveling on a surface 102. The vehicle 100 can be used with one or more other examples described elsewhere herein. The surface 102 (e.g., a roadway on which the vehicle 100 is traveling) is here provided with lane boundaries 104A-104E that are shown for illustrative purposes only. In some situations, only one (or none) of the lane boundaries 104A-104E may be present at the surface 102.

The lane boundaries 104A-104C are examples of lane markings that have a different visual appearance than the rest of the surface 102 (e.g., a different pigmentation, such as being darker or lighter). This visual contrast indicates the presence of a boundary lane when the lane boundaries 104A-104C are applied to the surface 102. The lane boundary 104A is here a solid line, the lane boundary 104B is a long broken line, and the lane boundary 104C is a short broken line. The individual segments of the lane boundary 104B can have about the same length as each other; similarly, the individual segments of the lane boundary 104C can have about the same length as each other. The segments of the lane boundary 104B can be longer than the segments of the lane boundary 104C.

The lane boundaries 104D-104E are examples of road markers that rely on a structural difference, and/or a visual contrast, with regard to the surface 102 in order to indicate the presence of a boundary lane. For example, the lane boundaries 104D-104E can cause a distinctive sound or vibration when contacted by the wheels of the vehicle 100 during travel. The lane boundary 104D is here formed by a row of physical objects affixed to or otherwise protruding from the surface 102. For example, the lane boundary 104D can be a Botts' dot, a turtle, a button, a reflective marker, or combinations thereof. The lane boundary 104E is here formed by a row of depressions in the surface 102 that can cause a distinctive sound or vibration when contacted by the wheels of the vehicle 100 during travel. For example, the lane boundary 102E can be a rumble strip.

The vehicle 100 includes one or more of sub-short range active light sensors 106A, 106B, 106C, or 106D for lane boundary detection. When the vehicle 100 has multiple sub-short range active light sensors, one or more of the multiple sub-short range active light sensors can be used in detecting a lane boundary in any particular situation.

The sub-short range active light sensors 106A-106D can be positioned at any of multiple positions at the vehicle 100. The sub-short range active light sensors 106A-106B are here positioned on the left side of the vehicle 100 from the driver's point of view and are oriented essentially in the left direction, and the sub-short range active light sensors 106C-106D are here positioned on the right side of the vehicle 100 and are oriented essentially in the right direction. The sub-short range active light sensors 106A and 106C are here positioned towards the front of the vehicle 100 (e.g., at or near the forward wheel wells). The sub-short range active light sensors 106B and 106D are here positioned towards the rear of the vehicle 100 (e.g., at or near the rear wheel wells). Other positions can be used.

The sub-short range active light sensors 106A-106D can use one or more types of scanning. Here, the sub-short range active light sensors 106A-106B are configured for 2D scanning, and the sub-short range active light sensors 106C-106D are configured for 3D scanning, solely for purposes of illustrating possible examples. In some implementations, the vehicle 100 may only have one of the sub-short range active light sensors 106A-106D, or if multiple ones of the sub-short range active light sensors 106A-106D are installed, they may all use a common type of scanning.

Here, the sub-short range active light sensor 106A performs scanning using a beam 108 that extends between the sub-short range active light sensor 106A and the surface 102. The sub-short range active light sensor 106A can scan (or sweep) the beam 108 in a single dimension (e.g., vertically up and down; that is, into and out of the plane of the present illustration). Because the sub-short range active light sensor 106A gathers depth data based on receiving the response signal associated with the beam 108, the resulting data has two dimensions (e.g., the vertical scan angle, and the depth). Hence, the sub-short range active light sensor 106A is said to perform 2D scanning. As such, a field of view 109 of the sub-short range active light sensor 106A here appears essentially as a line or a narrow strip. Similarly, the sub-short range active light sensor 106B can also be characterized as performing 2D scanning, and can have a similar field of view.

Here, the sub-short range active light sensor 106C performs scanning using a beam 110 that extends between the sub-short range active light sensor 106C and the surface 102. The sub-short range active light sensor 106C can scan (or sweep) the beam 110 in two dimension (e.g., vertically up and down, and also horizontally from side to side). Because the sub-short range active light sensor 106C gathers depth data based on receiving the response signal associated with the beam 110, the resulting data has three dimensions (e.g., the vertical scan angle, the horizontal scan angle, and the depth). Hence, the sub-short range active light sensor 106C is said to perform 3D scanning. As such, a field of view 112 of the sub-short range active light sensor 106C here appears essentially as a circle sector. Similarly, the sub-short range active light sensor 106D can also be characterized as performing 3D scanning, and can have a similar field of view.

The lane boundary detection using one or more of the sub-short range active light sensors 106A-106D can have different characteristics in various situations. In some implementations, the assumption can be made that if the vehicle 100 starts out driving within a particular lane (i.e., the lane is defined by way of its boundaries using some or all of the lane boundaries 104A-104E), then the sub-short range active light sensor needs to see the lane boundaries 104A, 104B, 104C, 104D, or 104E on at least one (e.g., both) sides of the vehicle 100. If the vehicle 100 begins driving while positioned on top of one or more of the lane boundaries 104A, 104B, 104C, 104D, or 104E, the sub-short range active light sensor (or the ADAS) may not reach convergence until more information becomes available (e.g., through one or more other sensors, such as a camera, or a high-definition map). With certain configurations (of height, angle, etc.) the ADAS may still see the lane markers of the adjacent lane(s) at a greater distance. For example, the ADAS can then decide that the vehicle is not currently in a lane. As such, the ADAS can operate in a fashion where the vehicle 100 is first determined to be reasonably in position within the lane boundaries 104A, 104B, 104C, 104D, or 104E, and thereafter one or more of the sub-short range active light sensors 106A-106D can be used for lane boundary detection according to the present subject matter.

The ADAS of the vehicle 100 can control the motion of the vehicle 100, and/or generate an alert, based on the lane boundary detection. As an example, the ADAS can be configured to take (or inhibit) a particular action upon determining that the vehicle 100 is properly within the lane. As another example, the ADAS can be configured to take (or inhibit) a particular action upon determining that the vehicle 100 is not properly within the lane. That is, a lane boundary detection can include detecting a lane boundary of the surface 102 (e.g., one or more of the lane boundaries 104A, 104B, 104C, 104D, or 104E), or a lane boundary detection can include detecting an absence of the lane boundary (e.g., that some or all of the lane boundaries 104A, 104B, 104C, 104D, or 104E is not detected), or both.

FIG. 1B shows other examples relating to the vehicle 100 in FIG. 1A. The sub-short range active light sensors 106A-106D can be calibrated before use. For example, a pre-calibrated sensor installation axis 114 is here shown as defined for the sub-short range active light sensor 106C with regard to the field of view 112. By calibrating sensor 106C relative to the vehicle coordinate system, axis 114, which can be perpendicular to the forward direction of the vehicle, can be mapped to the sensor's coordinate system. A line 116 can be defined as the direction of the shortest distance from the sub-short range active light sensor 106C to the lane boundary 104C. For example, the system can define a line 118 based on where the lane boundaries 104C have been detected, and the line 116 can then be determined as the shortest distance between the sub-short range active light sensor 106C and the line 118. The axis 114 is pre-calibrated relative to the vehicle coordinate system. The axis 114 may be non-perpendicular to the forward direction of the vehicle. If the calibration is not accurate, causing an error of the orientation angle of the axis 114, the shortest distance between the sub-short range active light sensor 106C and the line 118 will not be affected, and can still be measured correctly. The calculated yaw angle can take into account the error in the calibration of the axis 114. The calculation of departure angle using a trigonometric formula described below is not affected by the calibration error of the axis 114.

An angle of the vehicle 100 relative to the ego lane line can be determined using output from a single sensor. In FIG. 1B, this angle can be readily determined from the angle between axis 114 and line 116. As axis 114 can be mapped to the sensor coordinate system by pre-calibration, sensor 106C can be installed at any angle relative to the vehicle coordinate system, i.e., not necessarily parallel or perpendicular to the forward direction of the vehicle. For example, sensor 106C can be installed on the corners of the vehicle, partially facing the neighboring lane.

An angle of the vehicle 100 can be determined using output from multiple sensors. The angle calculation can be based on one or more detections made by two or more of the sub-short range active light sensors 106A-106D. Here, the sub-short range active light sensors 106A-106B can detect the lane boundary 104A, for example as described above. The sub-short range active light sensor 106A can output a value indicating a shortest distance D₁ between the sub-short range active light sensor 106A and the lane boundary 104A. Similarly, the sub-short range active light sensor 106B can output a value indicating a shortest distance D₂ between the sub-short range active light sensor 106B and the lane boundary 104A. Moreover, a distance L can be defined between the sub-short range active light sensors 106A-106B along the lane boundary 104A. The distance L can be known from the installation locations of the sub-short range active light sensors 106A-106B on the vehicle 100. An angle θ can then be determined using the following formula:

sin θ=(D₁−D₂)/L,

where sin is the trigonometric sine function. This method of calculating the angle is not affected by any calibration error of the pre-calibrated sensor installation axis 114 as D₁ and D₂ are the shortest distances that are actually measured by the sensors.

The sign of the result of the above formula indicates whether the vehicle 100 is traveling toward or away from the lane boundary 104A. Accordingly, the direction of the vehicle 100 can be estimated and used as input to one or more forms of motion control.

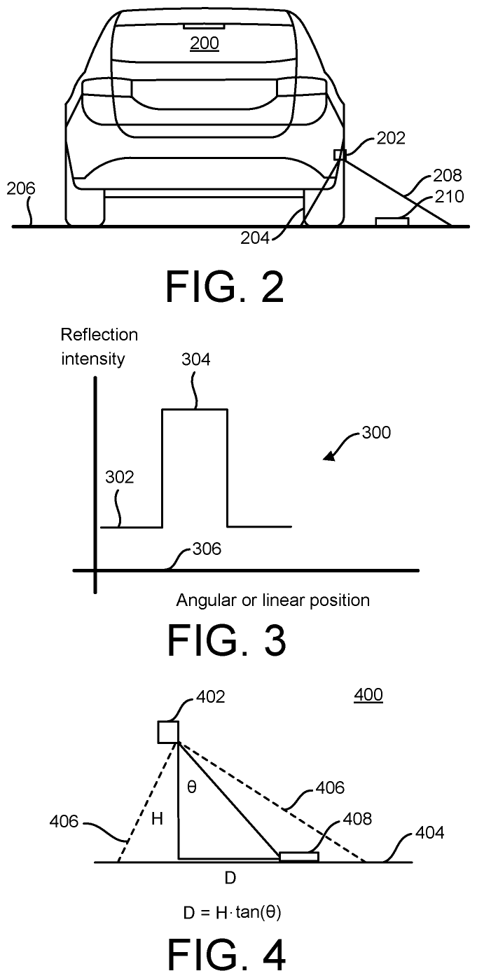

FIG. 2 shows a rear view of an example of a vehicle 200 traveling on a surface. The vehicle 200 can be used with one or more other examples described elsewhere herein. The vehicle 200 includes a sub-short range active light sensor 202 that can be positioned in any of multiple locations on the vehicle 200. Here, the sub-short range active light sensor 202 is located on a side of the vehicle 200, approximately at about the height where a wheel 204 is present. The vehicle 200 is currently positioned on (e.g., currently driving on top of) a surface 206.

The sub-short range active light sensor 202 is directed toward the surface 206. For example, the sub-short range active light sensor 202 can be aimed somewhat sideways from the vehicle 200 and toward the surface 206, wherein a field of view 208 (here schematically illustrated) is defined. A lane boundary 210 may be present at the surface 206. The lane boundary 210 is currently within the field of view 208, and the sub-short range active light sensor 202 can detect the lane boundary 210. Examples of detections and calculations that can be performed will now be described.

FIG. 3 shows an example graph 300 of a reflection intensity signal measured by a light sensor relating to detecting a lane boundary. The graph 300 can be used with one or more other examples described elsewhere herein. The diagram shows the graph 300 in terms of reflection intensity measured against a vertical axis, and angular or linear position of the laser beam reflection against a horizontal axis. That is, the reflection intensity indicates the intensity of the reflected laser light that is received by the active light sensor, and the angular or linear position is the direction from which the reflection is arriving. The sensor also measures the distance of the object, the road surface in this case, for the angular or linear positions within the scanning range, such that the reflection intensity and distance of the road surface within the scanning range is detected. This particular example illustrates one-dimensional scanning, i.e., with one angular or linear position variable for the arriving direction. For a two-dimensional scanning mechanism, the arriving direction has two angular or linear position variables.

The graph 300 can include at least one region 302 that is characterized by a relatively low reflection intensity over some range of angular or linear positions. For example, the region 302 can correspond to the active light sensor detecting a portion of the road surface where no lane boundary is present. The graph 300 can include at least one region 304 that is characterized by a relatively high reflection intensity over some range of angular or linear positions. In some implementations, the region 304 can correspond to the active light sensor detecting a lane boundary on the road surface. For example, the width of the region 304 in the graph 300 can indicate, in terms of angular or linear position, the spatial dimension of the lane boundary. As another example, a point 306 on the horizontal axis can represent the angular or linear position of the nearest point on the lane boundary. That is, the graph 300 illustrates that the active light sensor or the ADAS can perform a lane boundary detection based on a light reflection intensity of a road marker.

FIG. 4 shows an example of a geometric relationship 400 between the position of a sub-short range active light sensor 402 mounted on a vehicle, and a lane boundary on a surface. The geometric relationship 400 can be used with one or more other examples described elsewhere herein.

The sub-short range active light sensor 402 can be aimed toward a surface 404, wherein a field of view 406 (here schematically illustrated) is defined. A lane boundary 408 may be present at the surface 404. The lane boundary 408 is currently within the field of view 406. A height H here corresponds to the vertical elevation of the sub-short range active light sensor 402 above the surface 404. The height H can be known to the ADAS through a preceding calibration process. As another example, the height H can be extracted from the measurement results on the road; i.e., the smallest value in the measured height. An angle θ can represent the angular separation between the lane boundary 408 and the height H. The angle θ can be indicated by, or determined using, the output of the sub-short range active light sensor 402. For example, the point 306 (FIG. 3) can correspond to the angular or linear position of the lane boundary, and therefore the angle θ can be determined from the graph 300. A distance D between the location of the height H and the lane boundary 408 can be calculated. For example, D=H*tan(θ). Thus, the sub-short range active light sensor 402 can detect the lane boundary 408.

The following example illustrates how linear or angular positions can be extracted, with reference to the geometric relationship 400. In the case of a 2D active light sensor, such as the active light sensor 402, the point with the smallest distance can first be found in the measured points. This can correspond to the height H. Then the angular position (c angle θ) or linear position (distance D) can be measured from the shortest distance point. For example, the location of the lane can then still be accurate even if the sensor is tilted up or down, as the error is canceled.

When 3D scanning is performed (e.g., within the field of view 112 and performed by the sub-short range active light sensor 106C in FIGS. 1A-1B), the light from the active light sensor 402 is also characterized by an angle. For example, a calibration regarding the height H can be performed to facilitate the angle determination. The smallest horizontal distance from the sensor to the lane line or lane marker can be calculated from the measured data in a similar fashion. The horizontal location of the lane line can therefore be accurately determined when the angle is not zero or is not known accurately, e.g., when the vehicle's forward direction is not parallel with the lane line. The angle of the vehicle relative to the lane line can be determined from one or multiple sensors.

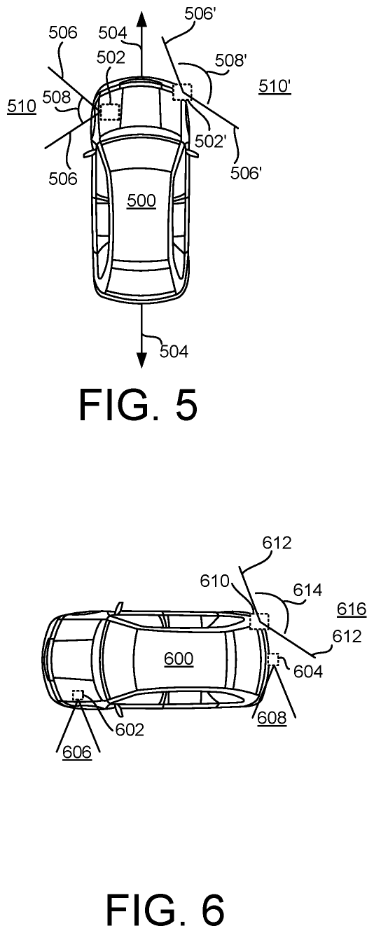

FIG. 5 shows a top view of an example of a vehicle 500 having a sub-short range active light sensor 502. The vehicle 500 or the sub-short range active light sensor 502 can be used with one or more other examples described elsewhere herein. The vehicle 500 is schematically shown to have a direction of travel 504, which is oriented along the longitudinal axis of the vehicle 500 in a forward direction (when traveling forward) or in a rearward direction (when traveling in reverse). The area that the sub-short range active light sensor 502 can observe using its laser beam can be defined in terms of at least two beam limits 506. The beam limits 506 represent the maximum angling of the laser beam in the present operation of the sub-short range active light sensor 502. Here, the beam limits 506 are separated by a scanning angle 508. The beam limits 506 and the scanning angle 508 define a field of view 510 for the sub-short range active light sensor 502.

Other locations on the vehicle 500 can be used. For example, the vehicle 500 can also or instead have a sub-short range active light sensor 502′ positioned substantially at a corner (e.g., at a front corner). The sub-short range active light sensor 502′ can be used with one or more other examples described elsewhere herein. The area that the sub-short range active light sensor 502′ can observe using its laser beam can be defined in terms of at least two beam limits 506′. The beam limits 506′ represent the maximum angling of the laser beam in the present operation of the sub-short range active light sensor 502′. Here, the beam limits 506′ are separated by a scanning angle 508′. The beam limits 506′ and the scanning angle 508′ define a field of view 510′ for the sub-short range active light sensor 502′. That is, the sub-short range active light sensor 502 and/or 502′ can detect the presence or absence of a lane boundary in the field of view 510 or 510′, respectively.

The active light sensor 502 and/or 502′ can be oriented so that the direction of travel 504 is within or outside the field of view 510 or 510′, respectively. In all implementations, the sub-short range active light sensor 502 and/or 502′ has a view of the lane boundary (which is generally expected to be to the side of the vehicle). Moreover, due to the relatively short distance between the sub-short range active light sensor 502 and 502′ and the lane boundaries, a significantly less powerful device can be used (e.g., the sub-short range active light sensor 502 or 502′ can be much less complex than LiDAR devices typically used in automotive applications).

FIG. 6 shows a top view of an example of a vehicle 600 having sub-short range active light sensors 602 and 604. The vehicle 600 or the sub-short range active light sensor 602 or 604 can be used with one or more other examples described elsewhere herein. The sub-short range active light sensor 602 is here positioned toward a side of the vehicle 600 and has a field of view 606. The sub-short range active light sensor 602 can be positioned on, at, or within a fender, door panel, side mirror, sill, frame, pillar, or roof of the vehicle 600, to name just a few examples. As such, the sub-short range active light sensor 602 can perform lane boundary detection at least to the side of the vehicle 600.

The sub-short range active light sensor 604 is here positioned toward at an end in a longitudinal direction of the vehicle 600 and has a field of view 608. For example, the sub-short range active light sensor 604 can be positioned at the front or the rear of the vehicle 600. The sub-short range active light sensor 604 can be positioned on, at, or within a fender, closure, sill, frame, hatch, liftgate, trunk lid, bumper, trailer hitch, spoiler, wing, or roof of the vehicle 600, to name just a few examples. As such, the sub-short range active light sensor 604 can perform lane boundary detection at least to the side of the vehicle 600.

Other locations on the vehicle 600 can be used. For example, the vehicle 600 can also or instead have a sub-short range active light sensor 610 positioned substantially at a corner (e.g., at a rear corner). The sub-short range active light sensor 610 can be used with one or more other examples described elsewhere herein. The area that the sub-short range active light sensor 610 can observe using its laser beam can be defined in terms of at least two beam limits 612. The beam limits 612 represent the maximum angling of the laser beam in the present operation of the sub-short range active light sensor 610. Here, the beam limits 612 are separated by a scanning angle 614. The beam limits 612 and the scanning angle 614 define a field of view 616 for the sub-short range active light sensor 610. That is, the sub-short range active light sensor 610 can detect the presence or absence of a lane boundary in the field of view 616.

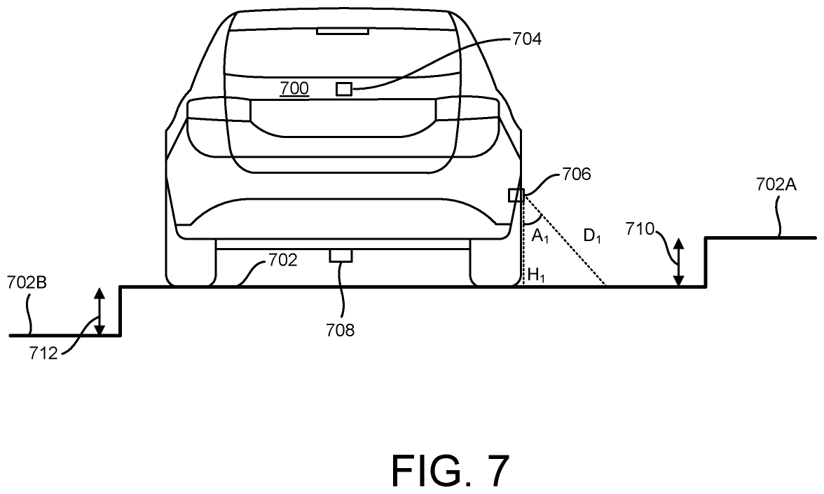

FIG. 7 shows a rear view of an example of a vehicle 700 traveling on a surface 702. The vehicle 700 has at least one of the following: a sub-short range active light sensor 704, a sub-short range active light sensor 706, or a sub-short range active light sensor 708. The vehicle 700 or the sub-short range active light sensor 704, 706, or 708 can be used with one or more other examples described elsewhere herein.

The sub-short range active light sensor 704, 706, and/or 708 can be mounted to the vehicle 700 in any of multiple respective locations. The sub-short range active light sensor 704 is here mounted at an end in a longitudinal direction of the vehicle 700. The sub-short range active light sensor 706 is here mounted at a side of the vehicle 700. The sub-short range active light sensor 708 is here mounted underneath the vehicle 700. Each of the sub-short range active light sensor 704, 706, and 708 is configured to detect a lane boundary of the surface 702 on which the vehicle 700 is traveling. Also, a direction of travel of the vehicle 700 is outside a field of view of the sub-short range active light sensors 704, 706, and 708.

The surface 702 can include one or more elevation differences serving as indicator(s) of where the lane begins or ends. Here, a region 702A is separated from the surface 702 by a height increase 710, so as to indicate that the lane of the surface 702 ends (i.e., has a boundary) where the region 702A begins. For example, the height increase 710 can correspond to a curb along which the vehicle 700 is traveling. Also, a region 702B is separated from the surface 702 by a height decrease 712, so as to indicate that the lane of the surface 702 ends (i.e., has a boundary) where the region 702B begins. For example, the height decrease 712 can correspond to the edge of a raised roadway surface on which the vehicle 700 is traveling.

The following example illustrates detection of a height difference. A height H₁ between the sensor and a surface can be determined using the following formula:

H₁=D₁ cos(A₁),

where the distance D₁ and the angle A₁ are measured by the sensor. When the determined height H₁ for the region 702A (or 702B) differs from the determined height for the surface 702, the lane boundary can be detected. This way, the sub-short range active light sensor 704, 706, and/or 708 can detect any of the above and/or other lane boundaries. For example, an ADAS can perform at least one action in response to the detection of the lane boundary.

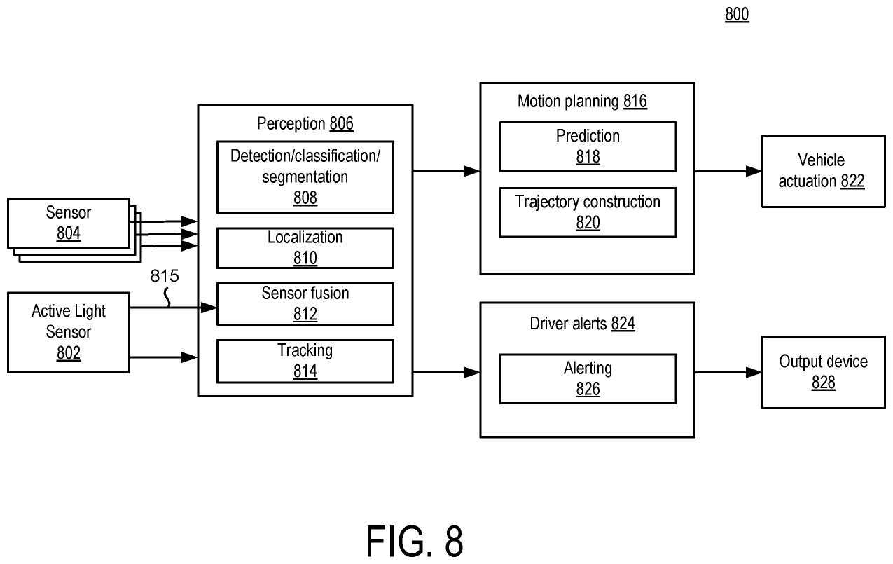

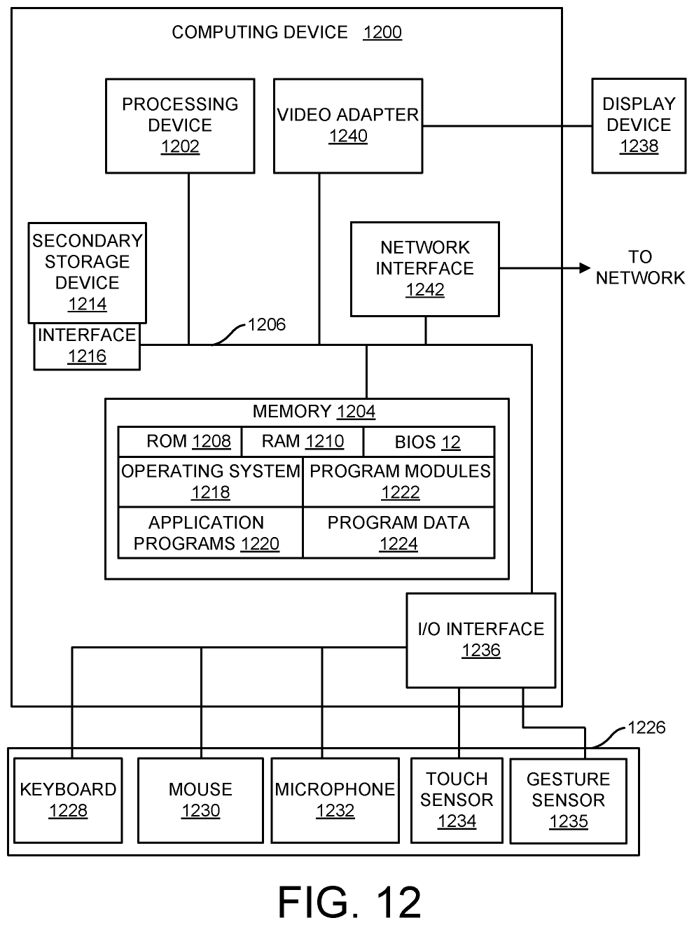

FIG. 8 shows an example of a system 800. The system 800 can be implemented as part of a vehicle and can be used with one or more other examples described elsewhere herein. The system 800 can be implemented using some or all components described with reference to FIG. 12 below. More or fewer components than shown can be used.

The system 800 in part includes a sub-short range active light sensor 802 and one or more sensors 804. The sub-short range active light sensor 802 can detect a lane boundary on a surface where the ego vehicle is traveling. The sensor(s) 804 can detect one or more aspects of the environment and/or situation. For example, video/image data, audio, and/or vibrations can be detected. Information from the sensor(s) 804 can be used in the lane boundary detection, for example as described below.

The system 800 includes a perception component 806 that receives sensor data from the sub-short range active light sensor 802 and optionally the sensor(s) 804 and performs object detection and tracking. This can be used to help the system 800 plan how to control an ego vehicle's behavior. The perception component 806 includes a component 808. For example, the component 808 can be configured to perform detection of objects (e.g., to distinguish the object from a road surface or other background). As another example, the component 808 can be configured to perform classification of objects (e.g., whether the object is a vehicle or a human). As another example, the component 808 can be configured to perform segmentation (e.g., to associate raw detection points into a coherent assembly to reflect the shape and pose of an object).

The perception component 808 can include a localization component 810. In some implementations, the localization component 810 serves to estimate the position of the vehicle substantially in real time. For example, the localization component 810 can use one or more sensor outputs, including, but not limited to, a global positioning system and/or a global navigation satellite system.

The perception component 808 can include a sensor fusion component 812. The sensor fusion component 812 can fuse the output from two or more sensors (e.g., the sub-short range active light sensor 802 and the sensor(s) 804) with each other in order to facilitate the operations of the perception component 808. In some implementations, this can facilitate that the perception component 808 can take into account both output from the sub-short range active light sensor 802, as well as other sensor output (e.g., from a radar or ultrasonic sensor), in performing a lane boundary detection. For example, if the lane detection based on the output from the sub-short range active light sensor 802 does not reach an unambiguous conclusion, the output from the sensor(s) 804 can be consulted to converge the determination (e.g., reach a conclusion as to where the lane boundary is). In some implementations, the sensor(s) 804 can include an audio sensor and its output can then be based on detecting audio using the audio sensor. For example, such audio can be generated by a wheel of the vehicle contacting a road marker on the surface. In some implementations, the sensor(s) 804 can include a vibration sensor and its output can then be based on detecting vibration using the vibration sensor. For example, such vibration can be generated by a wheel of the vehicle contacting a road marker on the surface.

The perception component 806 can include a tracking component 814. In some implementations, the tracking component 814 can track objects in the surroundings of the vehicle for purposes of planning vehicle motion. For example, objects such as other vehicles, bicycles, and/or pedestrians can be tracked in successive instances of sensor data processed by the perception component 806.

In some implementations, lane monitoring can be performed substantially without involving the perception component 806. For example, an arrow 815 here schematically represents to signal path wherein lane marker detection results from the active light sensor 802 go to the sensor fusion component 812 without passing through the software stack of the perception component 806. Namely, deep learning may not be required for lane marker detection. Rather, a relatively simple step detection of the return signal intensity (e.g., FIG. 3) or height/distance can be sufficient for detecting a lane marker edge. Such processing can be performed by the hardware that is part of the active light sensor 802 (e.g., by components of a LiDAR). A very high detection frequency can therefore be achieved. By contrast, if the perception component 806 (e.g., a software stack) were involved, a delay on the order of hundreds of milliseconds could occur, which may not be responsive enough for lane monitoring.

The system 800 includes a motion planning component 816. The motion planning component 816 can plan for the system 800 to perform one or more actions, or to not perform any action, in response to monitoring of the surroundings of the vehicle and/or an input by the driver. The output of one or more of the sensors as processed by the perception component 806 can be taken into account. The motion planning component 816 includes a prediction component 818. For example, the prediction component 818 uses the output of the perception component 806 (e.g., a tracked object) to make a prediction or estimation of likely future motion of the tracked object, and how this relates to current or planned motion of the vehicle. The motion planning component 816 includes a trajectory construction component 820. For example, the trajectory construction component 820 takes the prediction(s) generated by the prediction component 818, optionally together with information about the tracked object(s) from the perception component 806, and prepares a trajectory path for the vehicle.

The system 800 includes a vehicle actuation component 822. The vehicle actuation component 822 can control one or more aspects of the vehicle according to the path generated by the trajectory construction component 820. For example, the steering, gear selection, acceleration, and/or braking of the ego vehicle can be controlled. In some implementations, such motion control can, at least in some situations, be based on a lane boundary detection. For example, the system 800 can keep the vehicle within its lane (e.g., lane centering) using the vehicle actuation component 822.

The system 800 includes a driver alerts component 824. The driver alerts component 824 can use an alerting component 826 in generating one or more alerts based on registering the lane boundary detection. In some implementations, the alerting component 826 is configured for alert generation using any of multiple alert modalities (e.g., an audible, visual, and/or tactile alert). For example, the lane boundary detection can trigger an alert to the driver (e.g., a lane departure warning). The system 800 includes an output device 828 that can be used for outputting the alert. For example, the output device 828 includes a speaker, a display module, and/or a haptic actuator.

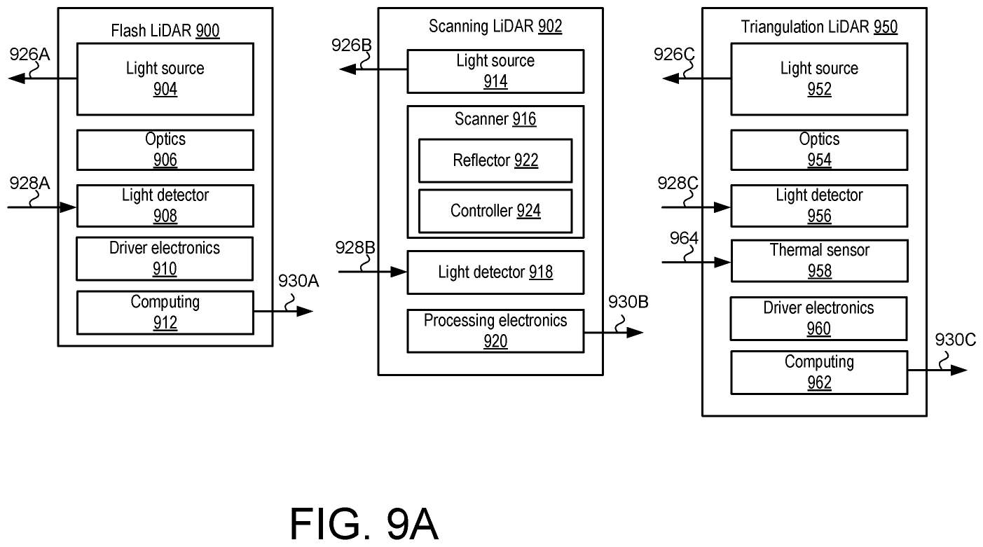

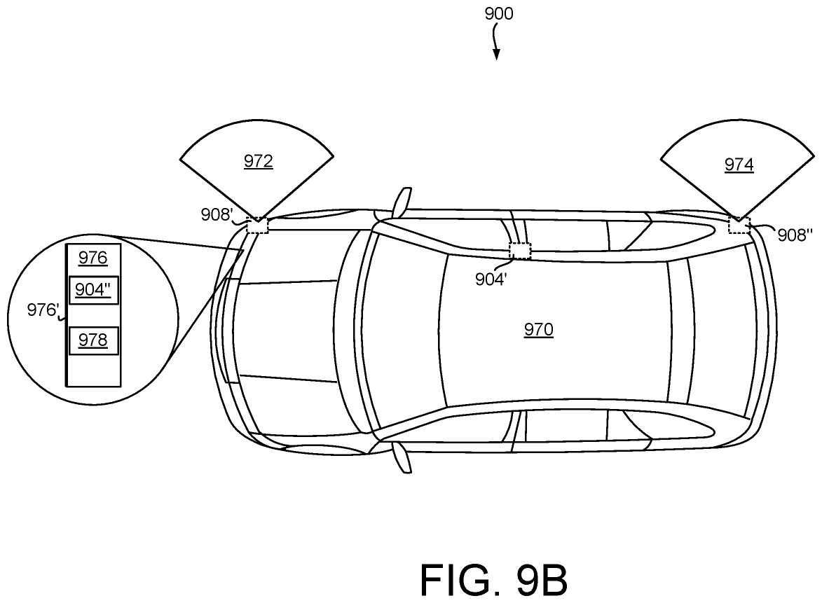

FIG. 9A shows examples of a flash LiDAR 900, a scanning LiDAR 902, and a triangulation LiDAR 950. Each of the flash LiDAR 900, the scanning LiDAR 902, and the triangulation LiDAR 950 is an example of a sub-short range active light sensor. One or more of the flash LiDAR 900, the scanning LiDAR 902, or the triangulation LiDAR 950 can be used with one or more other examples described elsewhere herein. The flash LiDAR 900, the scanning LiDAR 902, and/or the triangulation LiDAR 950 can be implemented using some or all components described with reference to FIG. 12 below. For example, the components of any of the flash LiDAR 900, the scanning LiDAR 902, and/or the triangulation LiDAR 950 can all be installed within a common housing. As another example, one or more of the components of any of the flash LiDAR 900, the scanning LiDAR 902, and/or the triangulation LiDAR 950 can be separate from at least one other component thereof.

The flash LiDAR 900 can be implemented as one or more physical devices operating together. Here, the flash LiDAR 900 includes at least one light source 904, optics 906, at least one light detector 908, driver electronics 910, and a computing component 912. Other components can be used additionally or alternatively.

In operation of the flash LiDAR 900, the light source 904 (which includes, e.g., a laser or a light-emitting diode) generates a flash of light which the optics 906 (e.g., one or more lenses and/or any other optical substrate) directs toward at least part of the surroundings of the flash LiDAR 900. The light detector 908 (which includes, e.g., a charge-coupled device or a complementary metal-oxide-semiconductor sensor) detects at least some of the emitted light that has been reflected by the surroundings. The driver electronics 910 (which includes, e.g., a chip or other integrated circuit) controls and synchronizes the operation of at least the light source 904 and the light detector 908. The computing component 912 (which includes, e.g., one or more processors executing instructions) performs calculations to determine one or more characteristics of the surroundings of the flash LiDAR 900.

The scanning LiDAR 902 includes a light source 914, a scanner 916, a light detector 918, and processing electronics 920. The light source 914 can include one or more components to generate coherent light. For example, a laser can be used. The wavelength(s) to be generated by the laser can be selected based on the capacity of the light detector 918, and/or on the intended surroundings and objects that the scanning LiDAR 902 should be used with.

The scanner 916 includes one or more reflector 922 and a controller 924. In some implementations, the reflector(s) 922 can be configured to reflect light from the light source 914 toward the surroundings of the scanning LiDAR 902, and, for light received by the scanning LiDAR 902, to reflect such light toward the light detector 918. As another example, in a biaxial design, one instance of the reflector 922 can reflect outgoing light arriving from the light source 914, and another instance of the reflector 922 can reflect incoming light toward the light detector 918. Controller 924 can control an orientation or other position of the reflector 922. In some implementations, the controller 924 can take into account output from an infrared camera and/or an event-based sensor in determining whether to increase the resolution of the imaging performed by the scanning LiDAR 902. Rotational angle and/or rotational speed of the reflector 922 can be controlled.

The light detector 918 includes one or more elements sensitive to at least the wavelength range intended to be detected (e.g., visible light). The light detector 918 can be based on charge-coupled devices or complementary metal-oxide semiconductors, to name just two examples.

The processing electronics 920 can receive output of the light detector 918 and information from the controller 924 (e.g., as to the current orientation of the reflector 922) and use them in generating LiDAR output.

In short, the light source 904 and/or 914 can generate light 926A or 926B, respectively. For example, the light 926A can be directed towards one or more portions of the surroundings of the flash LiDAR 900. As another example, using the reflector 922, the light 926B can be directed towards one or more portions of the surroundings of the scanning LiDAR 902. The light detector 908 can receive the light 928A, and/or the light detector 918 can receive the light 928B. For example, the light 928A or 928B can include reflections of the light 926A or 926B, respectively, from some or all of the surroundings of the flash LiDAR 900 or the scanning LiDAR 902. The computing component 912 can generate output 930A based on the output of the light detector 908. The processing electronics 920 can generate output 930B based on the output of the light detector 918.

The triangulation LiDAR 950 can be implemented as one or more physical devices operating together. Here, the triangulation LiDAR 950 includes at least one light source 952, optics 954, at least one light detector 956, a thermal sensor 958, driver electronics 960, and a computing component 962. Other components can be used additionally or alternatively.

In operation of the triangulation LiDAR 950, the light source 952 (which includes, e.g., a laser or a light-emitting diode) generates a flash of light. The wavelength(s) to be generated by the laser can be selected based on the capacity of the light detector 956, and/or on the intended surroundings and objects that the triangulation LiDAR 950 should be used with. The optics 954 (e.g., one or more lenses and/or any other optical substrate) directs the light toward at least part of the surroundings of the triangulation LiDAR 950. The light detector 956 (which includes, e.g., a charge-coupled device or a complementary metal-oxide-semiconductor sensor) detects at least some of the emitted light that has been reflected by the surroundings. The thermal sensor 958 is configured to detect thermal energy including, but not limited to, infrared radiation. That is, the thermal sensor 958 can detect thermal radiation from the surroundings that is not part of the active light emitted by the light source 952. As such, the thermal sensor 958 can be an add-on component to the triangulation LiDAR 950 (e.g., a separate passive thermal sensor on the vehicle to complement light sensors in the flash LiDAR 900, scanning LiDAR 902, and/or triangulation LiDAR 950 through sensor fusion). In some implementations, the thermal sensor 958 includes one or more pyroelectric sensors. For example, the thermal sensor 958 includes multiple sensor elements of pyroelectric material, and a difference in the sensor output signals can reflect the infrared radiation being detected. The driver electronics 960 (which includes, e.g., a chip or other integrated circuit) controls and synchronizes the operation of at least the light source 952, the light detector 956, and the thermal sensor 958. The computing component 962 (which includes, e.g., one or more processors executing instructions) performs calculations to determine one or more characteristics of the surroundings of the triangulation LiDAR 950.

In short, the light source 952 can generate light 926C. For example, the light 926C can be directed towards one or more portions of the surroundings of the triangulation LiDAR 950. The light detector 956 can receive light 928C. For example, the light 928C can include reflections of the light 926C from some or all of the surroundings of the triangulation LiDAR 950. The thermal sensor 958 can receive thermal radiation 964. For example, the thermal radiation 964 can include thermal emissions from some or all of the surroundings of the triangulation LiDAR 950. The computing component 962 can generate output 930C based on the output of the light detector 956 and the thermal sensor 958.

One or more of the components exemplified above can have characteristics making any or all of the flash LiDAR 900, the scanning LiDAR 902, or the triangulation LiDAR 950 a sub-short range active light sensor. For example, any or all of the flash LiDAR 900, the scanning LiDAR 902, or the triangulation LiDAR 950 can be a relatively inexpensive LiDAR device. In some implementations, at least one of the components exemplified above can provide that the maximum range is only less than about 3 m. For example, the maximum range can be only less than about 2 m, or less than about 1 m. In some implementations, at least the light source 904, 914 and/or 952 can provide that the operating power is less than about 5 W. For example, the operating power can be less than about 1 W. In some implementations, the driver electronics 910, the scanner 916, and/or the driver electronics 960 can provide that the frame rate is more than about 20 fps. For example, the frame rate can be more than about 50 fps, such as more than about 100 fps.

FIG. 9B shows an example involving the flash LiDAR 900 of FIG. 9A. The flash LiDAR 900 can have multiple instances of the light detector 908 that share the light source 904. Moreover, these light detectors 908 can all share the same housing as other components of the flash LiDAR 900, or one or more of the light detectors 908 can be separate from at least part of the flash LiDAR 900. The present example involves a vehicle 970 where the flash LiDAR 900 includes a light source 904′ installed near the B-pillar of the vehicle 970. The flash LiDAR 900 here includes light detectors 908′ and 908″ installed at respective locations on the vehicle 970. For example, the light detector 908′ is here installed near the front of the vehicle 970 and can have a field of view 972. As another example, the light detector 908″ is here installed near the rear of the vehicle 970 on the same side of the vehicle 970 as the light detector 908′ and can have a field of view 974. In operation of the flash LiDAR 900, the light emission of the light source 904′ can be synchronized with the operation of the light detectors 908′ and 908″ (e.g., the opening and closing of respective shutters of the light detectors 908′ and 908″). The light source 904′ can then illuminate the area toward the side of the vehicle 970, and the light detectors 908′ and 908″ can record return signals in their respective fields of view 972 or 974 at the same time.

In some implementations, the light source of the flash LiDAR 900 can be integrated with one or more other lights of the vehicle. Here, the flash LiDAR 900 has a light source 904″ that is integrated with the headlights of the vehicle 970. For example, the vehicle 970 can have a headlight housing 976 with an optically transparent face 976′. The light source 904″ and one or more headlights 978 can be positioned inside the headlight housing 976. Any type of headlight can be used for the headlight(s) 978. In some implementations, the headlight 978 can include an array of one or more light-emitting diodes (LEDs) and one or more lenses to collimate light from the LEDs.

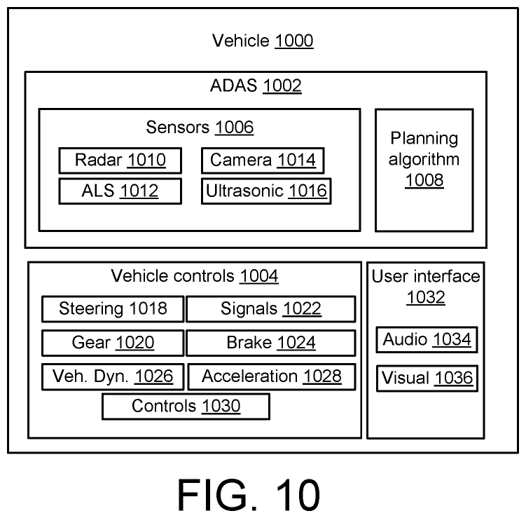

FIG. 10 shows an example of a vehicle 1000. The vehicle 1000 can be used with one or more other examples described elsewhere herein. The vehicle 1000 includes an ADAS 1002 and vehicle controls 1004. The ADAS 1002 can be implemented using some or all components described with reference to FIG. 12 below. The ADAS 1002 includes sensors 1006 and a planning algorithm 1008. Other aspects that the vehicle 1000 may include, including, but not limited to, other components of the vehicle 1000 where the ADAS 1002 may be implemented, are omitted here for simplicity.

The sensors 1006 are here described as also including appropriate circuitry and/or executable programming for processing sensor output and performing a detection based on the processing. The sensors 1006 can include a radar 1010. In some implementations, the radar 1010 can include any object detection system that is based at least in part on radio waves. For example, the radar 1010 can be oriented in a forward direction relative to the vehicle and can be used for detecting at least a distance to one or more other objects (e.g., another vehicle). The radar 1010 can detect the surroundings of the vehicle 1000 by sensing the presence of an object in relation to the vehicle 1000.

The sensors 1006 can include an active light sensor 1012. In some implementations, the active light sensor 1012 is a sub-short range active light sensor and can include any object detection system that is based at least in part on laser light. For example, the active light sensor 1012 can be oriented in any direction relative to the vehicle and can be used for detecting at least a distance to one or more other objects (e.g., a lane boundary). The active light sensor 1012 can detect the surroundings of the vehicle 1000 by sensing the presence of an object in relation to the vehicle 1000. The active light sensor 1012 can be a scanning LiDAR or a non-scanning LiDAR (e.g., a flash LiDAR), to name just two examples.

The sensors 1006 can include a camera 1014. In some implementations, the camera 1014 can include any image sensor whose signal(s) the vehicle 1000 takes into account. For example, the camera 1014 can be oriented in any direction relative to the vehicle and can be used for detecting vehicles, lanes, lane markings, curbs, and/or road signage. The camera 1014 can detect the surroundings of the vehicle 1000 by visually registering a circumstance in relation to the vehicle 1000.

The sensors 1006 can include an ultrasonic sensor 1016. In some implementations, the ultrasonic sensor 1016 can include any transmitter, receiver, and/or transceiver used in detecting at least the proximity of an object based on ultrasound. For example, the ultrasonic sensor 1016 can be positioned at or near an outer surface of the vehicle. The ultrasonic sensor 1016 can detect the surroundings of the vehicle 1000 by sensing the presence of an object in relation to the vehicle 1000.

Any of the sensors 1006 alone, or two or more of the sensors 1006 collectively, can detect, whether or not the ADAS 1002 is controlling motion of the vehicle 1000, the surroundings of the vehicle 1000. In some implementations, at least one of the sensors 1006 can generate an output that is taken into account in providing an alert or other prompt to a driver, and/or in controlling motion of the vehicle 1000. For example, the output of two or more sensors (e.g., the outputs of the radar 1010, the active light sensor 1012, and the camera 1014) can be combined. In some implementations, one or more other types of sensors can additionally or instead be included in the sensors 1006.

The planning algorithm 1008 can plan for the ADAS 1002 to perform one or more actions, or to not perform any action, in response to monitoring of the surroundings of the vehicle 1000 and/or an input by the driver. The output of one or more of the sensors 1006 can be taken into account. In some implementations, the planning algorithm 1008 can perform motion planning and/or plan a trajectory for the vehicle 1000.

The vehicle controls 1004 can include a steering control 1018. In some implementations, the ADAS 1002 and/or another driver of the vehicle 1000 controls the trajectory of the vehicle 1000 by adjusting a steering angle of at least one wheel by way of manipulating the steering control 1018. The steering control 1018 can be configured for controlling the steering angle though a mechanical connection between the steering control 1018 and the adjustable wheel, or can be part of a steer-by-wire system.

The vehicle controls 1004 can include a gear control 1020. In some implementations, the ADAS 1002 and/or another driver of the vehicle 1000 uses the gear control 1020 to choose from among multiple operating modes of a vehicle (e.g., a Drive mode, a Neutral mode, or a Park mode). For example, the gear control 1020 can be used to control an automatic transmission in the vehicle 1000.

The vehicle controls 1004 can include signal controls 1022. In some implementations, the signal controls 1022 can control one or more signals that the vehicle 1000 can generate. For example, the signal controls 1022 can control headlights, a turn signal and/or a horn of the vehicle 1000.

The vehicle controls 1004 can include brake controls 1024. In some implementations, the brake controls 1024 can control one or more types of braking systems designed to slow down the vehicle, stop the vehicle, and/or maintain the vehicle at a standstill when stopped. For example, the brake controls 1024 can be actuated by the ADAS 1002. As another example, the brake controls 1024 can be actuated by the driver using a brake pedal.

The vehicle controls 1004 can include a vehicle dynamic system 1026. In some implementations, the vehicle dynamic system 1026 can control one or more functions of the vehicle 1000 in addition to, or in the absence of, or in lieu of, the driver's control. For example, when the vehicle comes to a stop on a hill, the vehicle dynamic system 1026 can hold the vehicle at standstill if the driver does not activate the brake control 1024 (e.g., step on the brake pedal).

The vehicle controls 1004 can include an acceleration control 1028. In some implementations, the acceleration control 1028 can control one or more types of propulsion motor of the vehicle. For example, the acceleration control 1028 can control the electric motor(s) and/or the internal-combustion motor(s) of the vehicle 1000.

The vehicle controls can further include one or more additional controls, here collectively illustrated as controls 1030. The controls 1030 can provide for vehicle control of one or more functions or components. In some implementations, the controls 1030 can regulate one or more sensors of the vehicle 1000 (including, but not limited to, any or all of the sub-short range active light sensors 106A-106D of FIGS. 1A-1B). For example, the vehicle 1000 can adjust the settings (e.g., frame rates and/or resolutions) of the sensor(s) based on surrounding data measured by the sensor(s) and/or any other sensor of the vehicle 1000.

The vehicle 1000 can include a user interface 1032. The user interface 1032 can include an audio interface 1034 that can be used for generating an alert regarding a lane boundary detection. In some implementations, the audio interface 1034 can include one or more speakers positioned in the passenger compartment. For example, the audio interface 1034 can at least in part operate together with an infotainment system in the vehicle.

The user interface 1032 can include a visual interface 1036 that can be used for generating an alert regarding a lane boundary detection. In some implementations, the visual interface 1036 can include at least one display device in the passenger compartment of the vehicle 1000. For example, the visual interface 1036 can include a touchscreen device and/or an instrument cluster display.

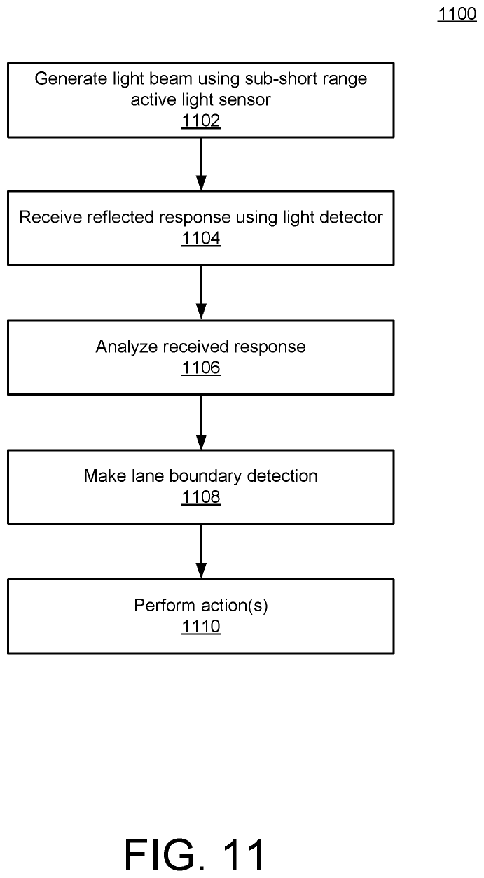

FIG. 11 shows an example of a method 1100. The method 1100 can be used with one or more other examples described elsewhere herein. More or fewer operations than shown can be performed. Two or more operations can be performed in a different order unless otherwise indicated.

At operation 1102, a light beam (e.g., a laser beam) can be generated using a sub-short range active light sensor mounted to a vehicle body. For example, the sub-short range active light sensor 106A (FIG. 1A) can generate the beam 108.

At operation 1104, a reflected response can be received using an light detector. For example, the light detector 908, 918 and/or 956 can receive the light 928A, 928B, or 928C, respectively. That is, in some implementations the operations 1102 and 1104 can be performed inside a sub-short range active light sensor.

At operation 1106, the received response can be analyzed. For example, processing can be performed on the graph 300 (FIG. 3).

At operation 1108, a lane boundary detection can be made. For example, the position of the vehicle 100 (FIGS. 1A-1B) relative to one or more of the lane boundaries 104A-104E can be determined.

At operation 1110, at least one action can be performed in response to the detection of the lane boundary. In some implementations, an ADAS performs the action. For example, vehicle motion can be controlled. As another example, a driver alert can be generated.

FIG. 12 illustrates an example architecture of a computing device 1200 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 12 can be used to execute the operating system, application programs, and/or software modules (including the software engines) described herein.

The computing device 1200 includes, in some embodiments, at least one processing device 1202 (e.g., a processor), such as a central processing unit (CPU). A variety of processing devices are available from a variety of manufacturers, for example, Intel or Advanced Micro Devices. In this example, the computing device 1200 also includes a system memory 1204, and a system bus 1206 that couples various system components including the system memory 1204 to the processing device 1202. The system bus 1206 is one of any number of types of bus structures that can be used, including, but not limited to, a memory bus, or memory controller; a peripheral bus; and a local bus using any of a variety of bus architectures.

Examples of computing devices that can be implemented using the computing device 1200 include a desktop computer, a laptop computer, a tablet computer, a mobile computing device (such as a smart phone, a touchpad mobile digital device, or other mobile devices), or other devices configured to process digital instructions.

The system memory 1204 includes read only memory 1208 and random access memory 1210. A basic input/output system 1212 containing the basic routines that act to transfer information within computing device 1200, such as during start up, can be stored in the read only memory 1208.

The computing device 1200 also includes a secondary storage device 1214 in some embodiments, such as a hard disk drive, for storing digital data. The secondary storage device 1214 is connected to the system bus 1206 by a secondary storage interface 1216. The secondary storage device 1214 and its associated computer readable media provide nonvolatile and non-transitory storage of computer readable instructions (including application programs and program modules), data structures, and other data for the computing device 1200.

Although the example environment described herein employs a hard disk drive as a secondary storage device, other types of computer readable storage media are used in other embodiments. Examples of these other types of computer readable storage media include magnetic cassettes, flash memory cards, solid-state drives (SSD), digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 1214 and/or system memory 1204, including an operating system 1218, one or more application programs 1220, other program modules 1222 (such as the software engines described herein), and program data 1224. The computing device 1200 can utilize any suitable operating system.

In some embodiments, a user provides inputs to the computing device 1200 through one or more input devices 1226. Examples of input devices 1226 include a keyboard 1228, mouse 1230, microphone 1232 (e.g., for voice and/or other audio input), touch sensor 1234 (such as a touchpad or touch sensitive display), and gesture sensor 1235 (e.g., for gestural input). In some implementations, the input device(s) 1226 provide detection based on presence, proximity, and/or motion. Other embodiments include other input devices 1226. The input devices can be connected to the processing device 1202 through an input/output interface 1236 that is coupled to the system bus 1206. These input devices 1226 can be connected by any number of input/output interfaces, such as a parallel port, serial port, game port, or a universal serial bus. Wireless communication between input devices 1226 and the input/output interface 1236 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device 1238, such as a monitor, liquid crystal display device, light-emitting diode display device, projector, or touch sensitive display device, is also connected to the system bus 1206 via an interface, such as a video adapter 1240. In addition to the display device 1238, the computing device 1200 can include various other peripheral devices (not shown), such as speakers or a printer.

The computing device 1200 can be connected to one or more networks through a network interface 1242. The network interface 1242 can provide for wired and/or wireless communication. In some implementations, the network interface 1242 can include one or more antennas for transmitting and/or receiving wireless signals. When used in a local area networking environment or a wide area networking environment (such as the Internet), the network interface 1242 can include an Ethernet interface. Other possible embodiments use other communication devices. For example, some embodiments of the computing device 1200 include a modem for communicating across the network.

The computing device 1200 can include at least some form of computer readable media. Computer readable media includes any available media that can be accessed by the computing device 1200. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 1200.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 12 is also an example of programmable electronics, which may include one or more such computing devices, and when multiple computing devices are included, such computing devices can be coupled together with a suitable data communication network so as to collectively perform the various functions, methods, or operations disclosed herein.

In some implementations, the computing device 1200 can be characterized as an ADAS computer. For example, the computing device 1200 can include one or more components sometimes used for processing tasks that occur in the field of artificial intelligence (AI). The computing device 1200 then includes sufficient proceeding power and necessary support architecture for the demands of ADAS or AI in general. For example, the processing device 1202 can include a multicore architecture. As another example, the computing device 1200 can include one or more co-processors in addition to, or as part of, the processing device 1202. In some implementations, at least one hardware accelerator can be coupled to the system bus 1206. For example, a graphics processing unit can be used. In some implementations, the computing device 1200 can implement a neural network-specific hardware to handle one or more ADAS tasks.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A vehicle comprising:
a vehicle body;
a sub-short range active light sensor mounted to the vehicle body and configured to detect a lane boundary of a surface on which the vehicle is traveling; and
an advanced driver-assistance system (ADAS) configured to register a lane boundary detection by the sub-short range active light sensor and perform an action in response to the lane boundary detection.

2. The vehicle of claim 1, wherein the sub-short range active light sensor is mounted underneath the vehicle, at an end in a longitudinal direction of the vehicle, or at a side of the vehicle.

3. The vehicle of claim 1, wherein the sub-short range active light sensor is configured to detect a lane marking as the lane boundary.

4. The vehicle of claim 1, wherein the sub-short range active light sensor is configured to detect a road marker as the lane boundary.

5. The vehicle of claim 1, wherein the sub-short range active light sensor is configured to detect an elevation difference in the surface as the lane boundary.

6. The vehicle of claim 1, wherein the sub-short range active light sensor generates a first output, the vehicle further comprising:
a sensor mounted to the vehicle to generate a second output; and
a sensor fusion component configured to fuse the first and second outputs with each other.

7. The vehicle of claim 6, wherein the sensor includes an audio sensor and wherein the second output is based on detecting audio using the audio sensor.

8. The vehicle of claim 7, wherein the audio is generated by a wheel of the vehicle contacting a road marker on the surface.

9. The vehicle of claim 6, wherein the sensor includes a vibration sensor and wherein the second output is based on detecting vibration using the vibration sensor.

10. The vehicle of claim 9, wherein the vibration is generated by a wheel of the vehicle contacting a road marker on the surface.

11. The vehicle of claim 1, wherein the lane boundary detection comprises at least one of detecting a lane boundary of the surface, or detecting an absence of the lane boundary.

12. The vehicle of claim 1, wherein the ADAS is configured to control motion of the vehicle based on registering the lane boundary detection.

13. The vehicle of claim 1, wherein the ADAS is configured to generate an alert based on registering the lane boundary detection.

14. The vehicle of claim 1, wherein the sub-short range active light sensor performs scanning in one dimension only.

15. The vehicle of claim 1, wherein the sub-short range active light sensor performs scanning in two dimensions.

16. The vehicle of claim 1, wherein the sub-short range active light sensor includes a flash light ranging and detection device.

17. The vehicle of claim 1, wherein the sub-short range active light sensor includes a triangulation light ranging and detection device.

18. The vehicle of claim 1, wherein the vehicle has multiple sub-short range active light sensors, and wherein the lane boundary is detected using at least one of the multiple sub-short range active light sensors.

19. The vehicle of claim 1, wherein the sub-short range active light sensor includes a light source and a light detector, and wherein the light source and the light detector are positioned in a common housing.

20. The vehicle of claim 1, wherein the sub-short range active light sensor includes a light source and a light detector, and wherein the light source and the light detector are not positioned in a common housing.

21. The vehicle of claim 20, wherein the sub-short range active light sensor includes the light source and multiple light detectors, wherein the multiple light detectors are installed at different locations on the vehicle, and wherein light emission of the light source and operation of the multiple light detectors are synchronized with each other.

22. The vehicle of claim 20, wherein the light source is integrated in a headlight of the vehicle.

23. A method comprising:
detecting a lane boundary of a surface on which a vehicle is traveling, the lane boundary detected using a sub-short range active light sensor mounted to the vehicle; and
performing, using an advanced driver-assistance system, an action in response to the detection of the lane boundary.
